(19) United States
(12) Patent Application Publication
(10) Pub. No.: US 2026/0106408 A1
(43) Pub. Date: Apr. 16, 2026

(54) CONNECTOR ASSEMBLY

(71) Applicant: Bellwether Electronic Corp., Taoyuan City (TW)

(72) Inventors: Yung-Liang CHI, Taoyuan City (TW); Yu-Yang HSU, Taoyuan City (TW)

(21) Appl. No.: 19/337,932

(22) Filed: Sep. 24, 2025

Related U.S. Application Data
(60) Provisional application No. 63/706,041, filed on Oct. 11, 2024.
(60) Provisional application No. 63/785,650, filed on Apr. 9, 2025.

(51) Int. Cl. H01R 13/633; H01R 13/506; H01R 13/627

(52) U.S. Cl. CPC H01R 13/6335; H01R 13/506; H01R 13/6275

(57) ABSTRACT

A connector assembly includes an elastic fixing unit, a housing, and a pulling unit. The elastic fixing unit has a holding portion and a transmission portion, in which the holding portion and the transmission portion are interlinked. The housing is connected to the elastic fixing unit. The pulling unit is movably connected to the housing and has a force-applying portion and a driving portion, in which the driving portion engages with the transmission portion, and the force-applying portion is configured to, upon receiving a force, drive the pulling unit to move along a direction of the force, such that the driving portion further drives the holding portion and the transmission portion to move.

### CROSS-REFERENCE TO RELATED APPLICATION

This application claims priority to U.S. Provisional Application No. 63/706,041, filed on Oct. 11, 2024, and U.S. Provisional Application No. 63/785,650, filed on Apr. 9, 2025, both of which are incorporated herein by reference in their entirety.

### BACKGROUND

### Field of Invention

The present invention relates to a connector assembly having a pull-tab.

### Description of Related Art

Mating and unmating connectors sometimes can be difficult due to their size and application conditions. This challenge becomes especially evident in situations where space is limited or multiple connectors are involved. In such cases, a user may find it difficult to apply force or to find a suitable point for applying force to the connector. Consequently, unplugging or disassembling the connector is difficult and inefficient. Sometimes, in order to unplug or disassemble a connector, a user may need to dismantle its housing or surrounding cables. This action can in turn lead to damage to the connector.

Furthermore, for some existing connection structures, it is difficult to balance stability and ease of operation after the connectors are connected and fixed. To ensure the reliability of the connection, more complex locking mechanisms are often required to fix the connector. However, when it is time to unplug or disassemble the connector, these complex locking mechanisms actually increase the difficulty of disassembly.

Therefore, how to design a connector that can be stably connected and easy to unplug or disassemble when needed has become a critical issue in the field.

### SUMMARY

To solve the aforementioned problems, the present disclosure provides a connector assembly that includes an elastic fixing unit, a housing, and a pulling unit. The elastic fixing unit has a holding portion and a transmission portion, in which the holding portion and the transmission portion are interlinked. The housing is connected to the elastic fixing unit. The pulling unit is movably connected to the housing and has a force-applying portion and a driving portion. The driving portion engages with the transmission portion. The force-applying portion is configured to, upon receiving a force, drive the pulling unit to move along a direction of the force, such that the driving portion further drives the transmission portion and the holding portion to move.

In some embodiments of the present disclosure, the housing includes a guiding portion. The guiding portion is configured to guide the driving portion to move along a first direction that is not parallel to the direction of the force.

In some embodiments of the present disclosure, the elastic fixing unit is a seesaw-like assembly. The holding portion and the transmission portion are the two relatively moving ends of this seesaw-like assembly.

In some embodiments of the present disclosure, the transmission portion includes a protruding body that extends substantially perpendicularly to the direction of the force. The driving portion includes a driving hole that engages with the protruding body.

In some embodiments of the present disclosure, the protruding body includes an extension portion extending along opposite sides of the protruding body. A width of the extension portion is greater than a width of the driving hole.

In some embodiments of the present disclosure, the housing includes a first limiting portion. The pulling unit includes an elongated through-hole extending along the direction of the force. The first limiting portion is movably engaged with the elongated through-hole. The first limiting portion is configured to stop the pulling unit when the pulling unit moves to a pre-set position along the direction of the force.

In some embodiments of the present disclosure, the first limiting portion is configured to limit the pulling unit in a second direction perpendicular to the direction of the force.

In some embodiments of the present disclosure, the housing includes a window. The window is aligned with the first limiting portion in a second direction perpendicular to the direction of the force.

In some embodiments of the present disclosure, the pulling unit further includes an assembly portion connected to the driving portion. The housing includes a second limiting portion that engages with the assembly portion. The second limiting portion is configured to limit the assembly portion in a planar direction perpendicular to the direction of the force.

In some embodiments of the present disclosure, the second limiting portion includes at least one limiting post extending in a direction opposite to the direction of the force. The driving portion includes at least one assembly hole, in which the at least one limiting post respectively engages with the at least one assembly hole.

In some embodiments of the present disclosure, the force-applying portion includes a plurality of ribs extending parallel to each other.

In some embodiments of the present disclosure, the force-applying portion includes two adjacent force-applying holes.

Another objective of the present disclosure is to provide a connector assembly that includes an elastic fixing unit, a housing, and a pulling unit. The elastic fixing unit has a holding portion, a transmission portion, and a connecting portion located between the fixing potion and the transmission portion, and the transmission and holding portions are interlinked. The housing is connected to the elastic fixing unit via the connecting portion. The pulling unit is movably connected to the housing and engages with the connecting portion. The pulling unit has a force-applying portion and a driving portion. The force-applying portion is configured to, upon receiving a force, drive the pulling unit to move along a direction of the force, such that the driving portion moves toward the transmission portion to pull and move the transmission portion and the holding portion.

In some embodiments of the present disclosure, the driving portion is configured to move by elastically deforming along a first direction not parallel to the direction of the force.

In some embodiments of the present disclosure, the driving portion is substantially L-shaped and is partially located above the transmission portion. One end of the driving portion is located on a side of the transmission portion facing away from the holding portion.

In some embodiments of the present disclosure, the housing includes a limiting portion. The pulling unit includes an elongated through-hole extending along the direction of the force. The limiting portion is movably engaged with the elongated through-hole and is configured to stop the pulling unit when the pulling unit moves to a pre-set position along the direction of the force.

In some embodiments of the present disclosure, the limiting portion is configured to limit the pulling unit in a second direction perpendicular to the direction of the force.

In some embodiments of the present disclosure, the limiting portion is substantially T-shaped.

In some embodiments of the present disclosure, the pulling unit is a pull-tab.

In some embodiments of the present disclosure, the elastic fixing unit is a latch. The holding portion and the transmission portion are the two relatively moving ends of the latch. The holding portion can be unlocked by pulling or pushing the transmission portion.

The connector assembly is configured to allow a user to quickly unlock and separate the connector, even in space-limited conditions. Firstly, the disclosure adopts a special elastic fixing unit, which allows the mating connector to be easily released via the pulling unit. Secondly, to ensure the lasting and stable performance of the connector, the disclosure cleverly integrates multiple sophisticated guiding structures, such as the limiting portion and the guiding portion. These structures can precisely guide the movement of the pulling unit. This precise guidance in turn ensures the smoothness and precision of the pulling unit's movement.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of the connector assembly of the present disclosure, and certain components are shown in dashed lines to indicate transparency.

FIG. 2 is an exploded view of the connector assembly of the present disclosure.

FIG. 3 is a perspective view of the connector assembly of the present disclosure from another viewing angle.

FIG. 4 is a perspective view of the connector assembly of the present disclosure from another viewing angle.

FIG. 5 is a rear view of the connector assembly of the present disclosure.

FIGS. 6 and 7 are cross-sectional views taken along the section line C in FIG. 3, and FIGS. 6 and 7 are shown in different states, respectively.

FIG. 8 is a perspective view of the cable-end connector in other embodiments of the present disclosure.

FIG. 9 is a perspective view of the cable-end connector in other embodiments of the present disclosure.

FIG. 10 is a perspective view of the cable-end connector in other embodiments of the present disclosure.

FIG. 11 is a perspective view of the cable-end connector in some embodiments of the present disclosure.

FIG. 12 is a perspective view of the cable-end connector of FIG. 11 from another viewing angle.

FIGS. 13 and 14 are perspective sectional views of the cable-end connector of FIG. 11, and FIGS. 13 and 14 are shown in different states, respectively.

### DETAILED DESCRIPTION

The objectives, technical features, and advantages of the present disclosure are further described below with reference to the accompanying drawings. However, it should be understood that the specific embodiments described below are for illustrating the present disclosure and not for limiting its scope. In the description and drawings, the same component symbols generally represent the same or functionally similar parts. Furthermore, for ease of description, a first axis X, a second axis Y, and a third axis Z are defined as being generally perpendicular to each other. These axes serve as a reference for describing the relative positions, arrangement relationships, and force directions of the components.

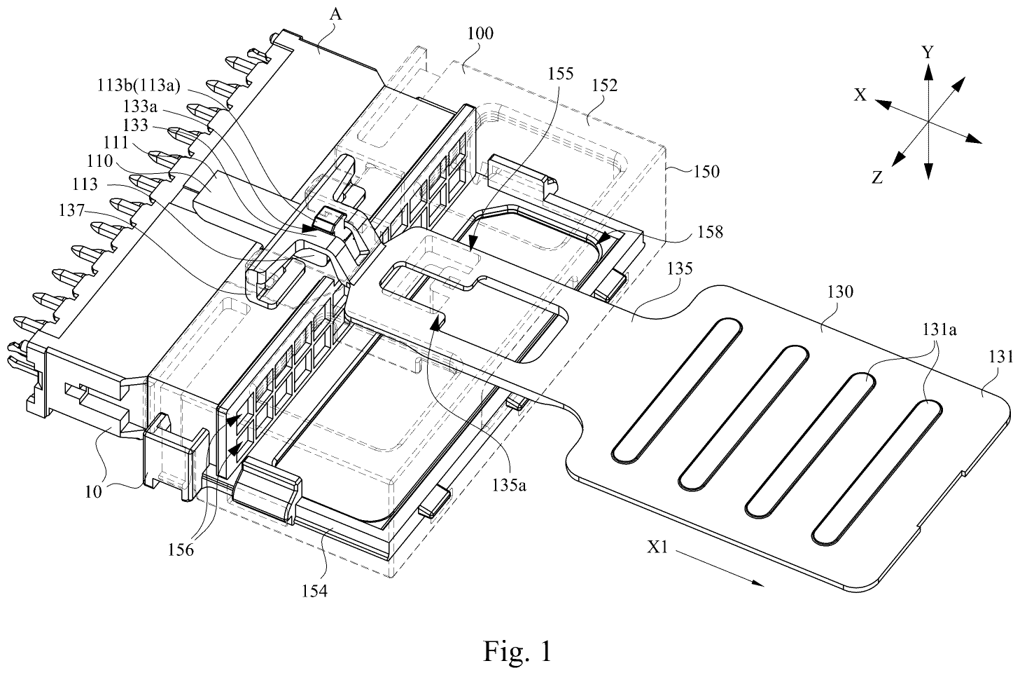

Please refer to FIGS. 1-5. In some embodiments of the present disclosure, the connector assembly 10 includes a cable-end connector 100 and a mating connector A. The cable-end connector 100 includes an elastic fixing unit 110, a pulling unit 130, and a housing 150. Furthermore, the cable-end connector 100 is connected to the mating connector A (e.g., a board-end connector on a circuit board) via the elastic fixing unit 110. The pulling unit 130 drives the elastic fixing unit 110 to be detached from the mating connector A. The housing 150 provides functions such as protection and support. These components enable the cable-end connector 100 to easily mate with the mating connector A. The components of the cable-end connector 100 and the mating connector A will be described in detail below.

The elastic fixing unit 110 has a holding portion 111, a transmission portion 113, and a connecting portion 115 located between the holding portion 111 and the transmission portion 113, in which the holding portion 111 and the transmission portion 113 are interlinked. The elastic fixing unit 110 is elastic and can undergo controllable and recoverable relative motion. The holding portion 111 and the transmission portion 113 can move relative to a rigid connecting portion 115 or a flexible connecting portion 115. Specifically, the elastic fixing unit 110 can be made of an elastic material, such as elastic plastic or elastic alloy, but the disclosure is not limited thereto. In addition, the transmission portion 113 and the holding portion 111 are interlinked, which means that the movement of the transmission portion 113 guides the subsequent movement of the holding portion 111, and vice versa.

The pulling unit 130 may include a pull-tab, in which the pulling unit 130 has a force-applying portion 131 at the rear side and a driving portion 133 at the front side. The transmission portion 113 of the elastic fixing unit 110 engages with and is driven by the driving portion 133. A user can apply a force to the force-applying portion 131 along a direction of the force X1, which is a linear direction on the first axis X. This causes the entire pulling unit 130 to move generally along the direction of the force X1. Furthermore, the driving portion 133 is configured to actuate the elastic fixing unit 110. Specifically, the pulling unit 130 is generally made of a wear-resistant plastic material with a certain strength, such as polycarbonate (PC), nylon, or a flexible plastic material, but the disclosure is not limited thereto.

The housing 150 is movably connected to the pulling unit 130, such that the pulling unit 130 has limited movement relative to the housing 150 and is movable relative to the housing 150 along the first axis X. The housing 150 provides support, protection, and positioning for the various components of the cable-end connector 100. The housing 150 is generally made of an insulating plastic material with good mechanical strength, such as flexible plastic, polycarbonate (PC), or nylon (PA). Furthermore, the housing 150 includes a first housing 152, a second housing 154, and a plurality of mating channels 156 extending along the first axis X. The first housing 152, the second housing 154, and the mating channels 156 are fixed to each other and jointly protect components inside the housing 150. A through-hole 158 is disposed at a bottom of the second housing 154, and the through-hole 158 is adjacent to the mating channels 156. Contact parts of cable terminals can be accommodated in the mating channels 156, while cables of the terminals can extend through the through-hole 158. In some embodiments, the mating channels 156 can be integrally formed with the first housing 152 or the second housing 154. However, the mating channels 156 can also be separate components, and the disclosure is not limited thereto.

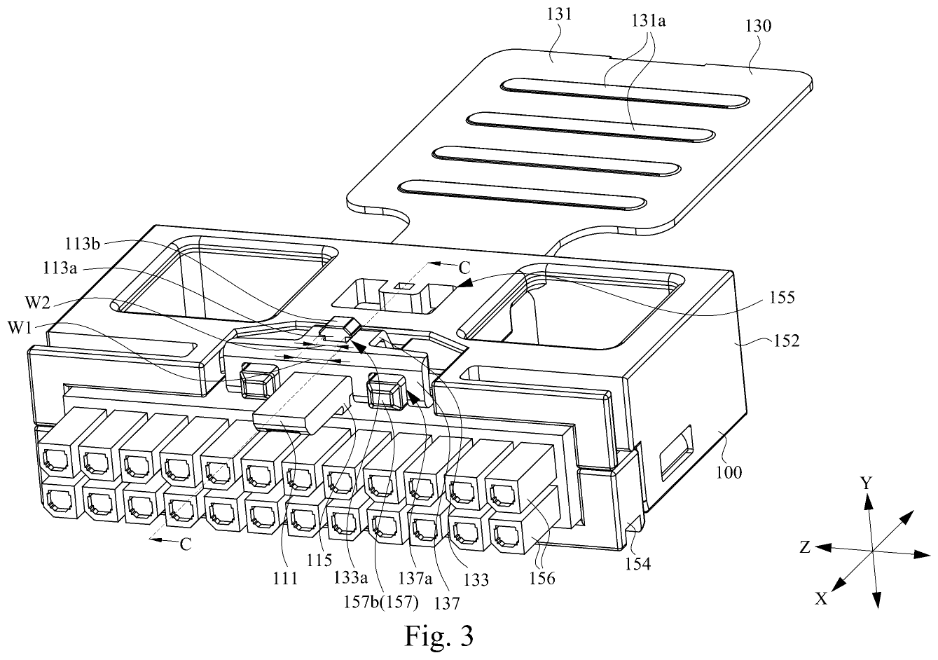

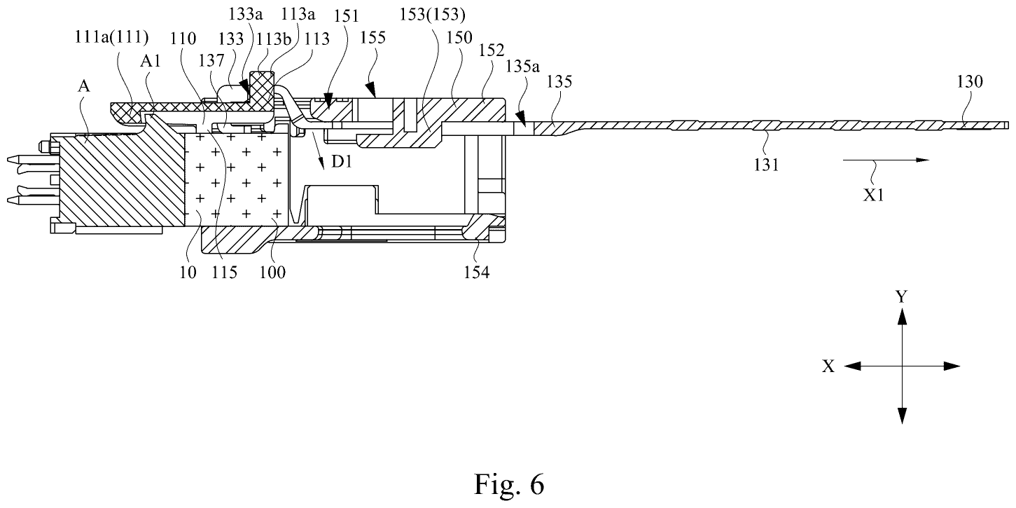

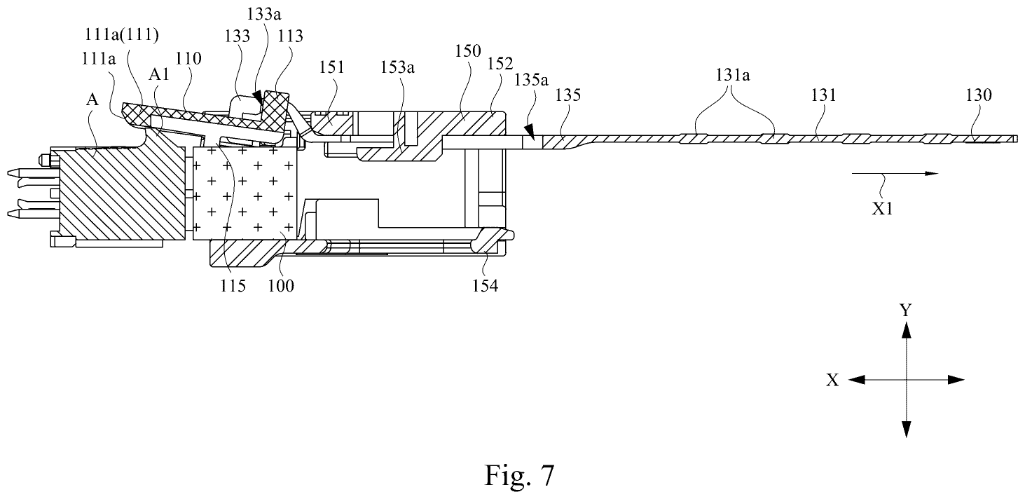

Please also refer to FIGS. 6 and 7, which are cross-sectional views taken along the section line C in FIG. 3, and FIGS. 6 and 7 are shown in different states. In some embodiments, the elastic fixing unit 110 is a seesaw-like assembly. The holding portion 111 and the transmission portion 113 are located at the two relatively moving ends of this assembly, and the connecting portion 115 can be a pivot of the seesaw-like assembly. The holding portion 111 is detachably connected to the mating connector A. The holding portion 111 may include a hook body 111a, and the mating connector A includes a corresponding hook portion A1. The holding portion 111 is configured to move toward or away from the mating connector A, thereby causing the hook body 111a to latch onto or release from the hook portion A1. In other embodiments, the elastic fixing unit 110 is a latch. The holding portion 111 and the transmission portion 113 are the two relatively moving ends of the latch. A user can pull or push the transmission portion 113 to drive the holding portion 111 to lock or unlock the hook portion A1.

Please refer to FIGS. 6 and 7. In some embodiments, the housing 150 includes a guiding portion 151, which has a guiding surface or a guiding channel that is not parallel to the direction of the force X1. The guiding portion 151 is configured to guide the driving portion 133 of the pulling unit 130 to move along a first direction D1 that is not parallel to the direction of the force X1. In some embodiments, the guiding surface of the guiding portion 151 is inclined with respect to the first axis X. The guiding surface generally faces in a direction different from the direction of the force X1. This causes the first direction D1 to be inclined relative to the direction of the force X1. For example, the first direction D1 and the direction of the force X1 form an acute angle. As a result, the driving portion 133 is driven to move along both the first axis X and the second axis Y. In other embodiments, the guiding surface of the guiding portion 151 is perpendicular to the first axis X and faces in a direction different from the direction of the force X1. The first direction D1 is perpendicular to the direction of the force X1, thereby driving the driving portion 133 to move downward along the second axis Y. The driving portion 133 pulls the transmission portion 113 downward along the second axis Y, so the holding portion 111 can release the mating connector A more effectively than if the transmission portion 113 were to move only along the first axis X1.

That is, when a user intends to operate this cable-end connector 100, the user can apply a force to the force-applying portion 131 of the pulling unit 130 along the direction of the force X1. This force drives the driving portion 133 of the pulling unit 130 to have a tendency to move in the direction of the force X1. However, through the interaction between the guiding portion 151 of the housing 150 and the pulling unit 130, the direction of motion of the driving portion 133 is guided to the first direction D1. The first direction D1 is not parallel to the direction of the force X1. Through this change in direction, the driving portion 133 can effectively drive the transmission portion 113 to move. This in turn causes the holding portion 111 to lift up and release the mating connector A. It should be noted that the user only needs to apply force along a single direction of the force X1. This single action completes both the unlocking of the cable-end connector 100 and the separation from the mating connector A. Compared to conventional connectors, the present disclosure can significantly simplify the disassembly process and reduce operational difficulty. Even in space-constrained environments, the user can conveniently separate the cable-end connector 100 and the mating connector A. This effectively improves operational efficiency and reduces the risk of damaging the connector assembly 10.

Please refer to FIGS. 1-5. In some embodiments, the transmission portion 113 may include a protruding body 113a, and the driving portion 133 includes a driving hole 133a. The protruding body 113a extends through and engages with the driving hole 133a. The driving hole 133a is configured to drive the transmission portion 113 to move, which causes the holding portion 111 to lift up and release the mating connector A. Specifically, the protruding body 113a includes a columnar main body and is located on an upper surface of the transmission portion 113. Please refer to FIG. 6. When the mating connector A is locked to the cable-end connector 100, the protruding body 113a extends substantially perpendicularly to the direction of the force X1. Please refer to FIG. 7. When the cable-end connector 100 releases the mating connector A, the extension direction of the protruding body 113a will be slightly inclined to the direction of the force X1. It should be noted that “substantially perpendicularly” means that, in the initial stage of force application shown in FIG. 6, the angle between the extension direction of the protruding body 113a and the direction of the force X1 is close to or equal to 90 degrees. For example, this angle can be in the range of 80 to 100 degrees, but the disclosure is not limited thereto. In some embodiments, a side of the protruding body 113a closer to the holding portion 111 abuts a sidewall of the driving hole 133a and forms a recess along the first axis X. This recess secures the engagement between the protruding body 113a and the driving hole 133a.

In some embodiments, the protruding body 113a is substantially T-shaped or cross-shaped. The protruding body 113a may include an extension portion 113b extending along opposite directions in the third axis Z. A width W1 of the extension portion 113b is greater than a width W2 of the driving hole 133a. Additionally, the driving hole 133a engages below the extension portion 113b. The extension portion 113b can limit the driving portion 133 in the second axis Y direction, thereby preventing the driving portion 133 from disengaging upward from the transmission portion 113 during movement. When the driving portion 133 moves along the first direction D1 (please refer to FIG. 6), an inner wall of the driving hole 133a pulls the protruding body 113a and drives the transmission portion 113 to move. This causes the holding portion 111 to move away from the mating connector A.

Please refer to FIGS. 1 to 5. In some embodiments, the housing 150 may include a first limiting portion 153, and the pulling unit 130 includes a main body portion 135 and an elongated through-hole 135a extending in the main body portion 135. The main body portion 135 is located between the force-applying portion 131 and the driving portion 133, and the elongated through-hole 135a extends mainly along the direction of the force X1. Specifically, the first limiting portion 153 is movably engaged with a part of the elongated through-hole 135a. The first limiting portion 153 is configured to stop the pulling unit 130 when the pulling unit 130 moves along the direction of the force X1 to a pre-set position. This pre-set position is where an end of the elongated through-hole 135a contacts the first limiting portion 153. This limits the relative movement between the pulling unit 130 and the housing 150 on the first axis X. Furthermore, a portion of the main body 135 adjacent to the elongated through-hole 135a is thicker than other parts of the main body 135. By increasing the thicker portion, the main body portion 135 have enhanced structural strength and durability when subjected to pulling forces.

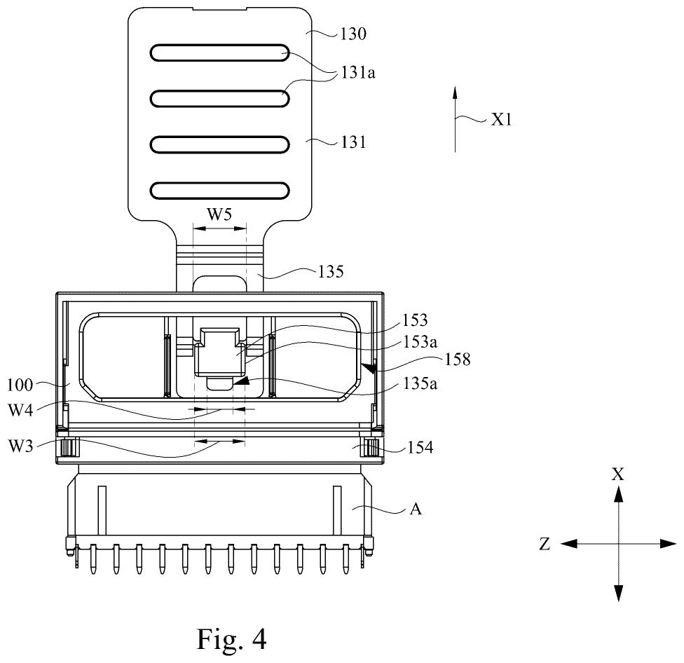

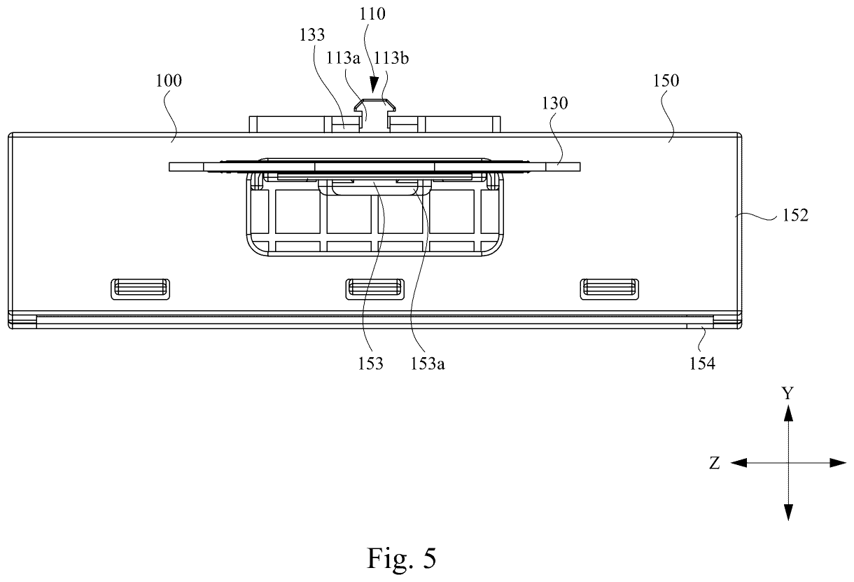

Please refer to FIGS. 4 and 5. In some embodiments, the first limiting portion 153 is also used to limit and support the pulling unit 130 in a second direction perpendicular to the direction of the force X1 (e.g., the second axis Y). The first limiting portion 153 includes limiting arms 153a extending along opposite directions in the third axis Z. A width W3 of the limiting arms 153a is greater than a width W4 of a portion of the elongated through-hole 135a. Therefore, the limiting arms 153a can limit and support the pulling unit 130 from below the main body portion 135. This configuration allows the main body portion 135 to move straight along the direction of the force X1 without deviating along the second axis Y. Furthermore, a width W5 of another part of the elongated through-hole 135a is substantially equal to or slightly greater than the width W3 of the limiting arms 153a. This facilitates the engagement or disengagement of elongated through-hole 135a of the pulling unit 130 with the first limiting portion 153.

Please refer to FIGS. 1-3. In some embodiments, for ease of observation or assembly, the housing 150 may include a window 155. This window 155 is aligned with the first limiting portion 153 in a second direction perpendicular to the direction of the force X1. When the pulling unit 130 is correctly assembled within the housing 150, the window 155 will align with and expose at least a part of the main body portion 135. Conversely, if the pulling unit 130 is not assembled with the housing 150, the window 155 will expose the first limiting portion 153. A user can determine whether the pulling unit 130 is properly assembled by observing the window 155. Specifically, the window 155 can be U-shaped and include two window portions extending parallel to each other. These two window portions are respectively aligned with two opposite sides of the limiting arms 153a. When the pulling unit 130 is assembled in the housing 150, the user can observe that the pulling unit 130 covers the two opposite sides of the limiting arms 153a, thereby confirming proper assembly.

Please refer to FIGS. 1-3. In some embodiments, the housing 150 includes a second limiting portion 157. The pulling unit 130 includes an assembly portion 137 connected to a front side of the driving portion 133. The assembly portion 137 engages with the second limiting portion 157, and the driving portion 133 can have limited movement relative to the assembly portion 137. In practical application, if the pulling unit 130 is made of an elastic material, the deformation of the assembly portion 137 is relatively smaller when a user applies force to the pulling unit 130. Meanwhile, the driving portion 133 undergoes greater deformation and movement, thereby driving the transmission portion 113. When the external force is released, the pulling unit 130 automatically resets the driving portion 133 and assembly portion 137 by its own elasticity. Furthermore, the assembly portion 137 is substantially L-shaped, and a portion of the assembly portion 137 can be inserted into the housing 150. This is beneficial for securely fixing the assembly portion 137 to the housing 150.

Furthermore, the second limiting portion 157 can at least limit and stop the assembly portion 137 in the direction of the force X1. The second limiting portion 157 includes a stopping surface 157a and limiting posts 157b. The stopping surface 157a extends generally perpendicularly to the first axis X, while the limiting posts 157b extend in a direction opposite to the direction of the force X1. Correspondingly, the assembly portion 137 includes assembly holes 137a, and the limiting posts 157b extend through and engage with the assembly holes 137a. With this configuration, the limiting posts 157b can limit the movement of the assembly portion 137 in a planar direction. Moreover, the stopping surface 157a can contact and block the assembly portion 137 in the direction of the force X1. Through this combined action, the movement of the pulling unit 130 relative to the housing 150 is effectively controlled. This ensures that the driving portion 133 moves accurately in the intended direction.

In some embodiments, the second limiting portion 157 includes two limiting posts 157b resembling cow horns, which can be curved or straight. The elastic fixing unit 110 is positioned between these two limiting posts 157b. The two limiting posts 157b pass through and engage with the two assembly holes 137a of the pulling unit 130. The driving portion 133 is located between the two limiting posts 157b, and the direction of movement is guided by the extension direction of the two limiting posts 157b. These two limiting posts 157b enable the driving portion 133 to accurately drive the elastic fixing unit 110. This design not only provides more stable support and positioning for the elastic fixing unit 110 but also is beneficial for reducing shaking or unintended displacement, thereby ensuring accuracy and reliability.

Please refer to FIG. 3. In some embodiments, the force-applying portion 131 may include a plurality of ribs 131a extending parallel to each other. The ribs 131a are beneficial for improving the user's tactile sensation, grip stability, and operational convenience.

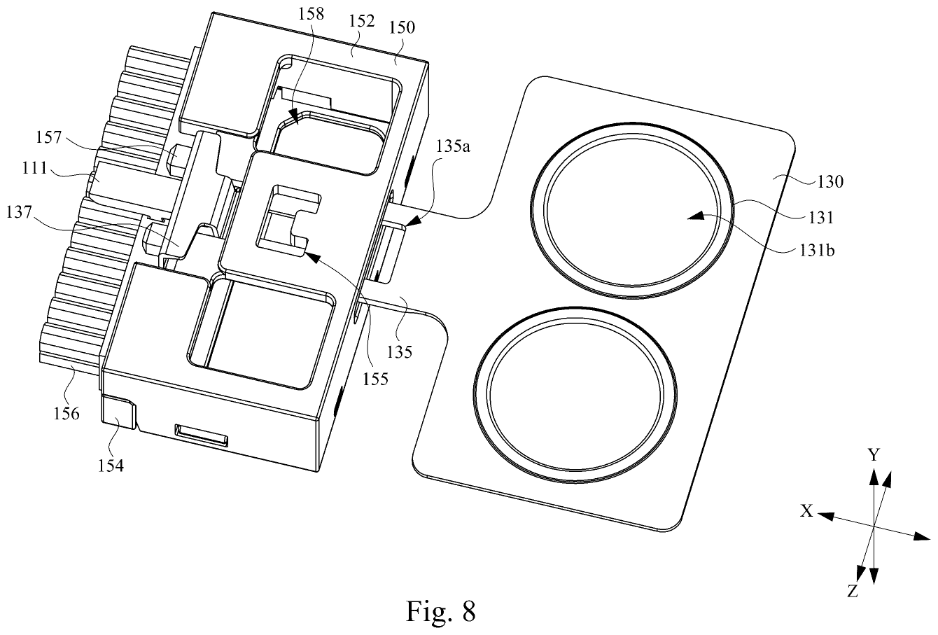

Please refer to FIG. 8, which is a perspective view of a cable-end connector 100 according to other embodiments. In these embodiments, the force-applying portion 131 includes two adjacent force-applying holes 131b. A user can insert two fingers into the force-applying holes 131b and apply a pulling force. This action drives the pulling unit 130 and is beneficial for effective and stable control over the operation of the elastic fixing unit 110. Furthermore, the force-applying portion 131 can also have circular thickened layers around edges of the holes. This design ensures that the user does not feel discomfort, thereby improving the operating experience.

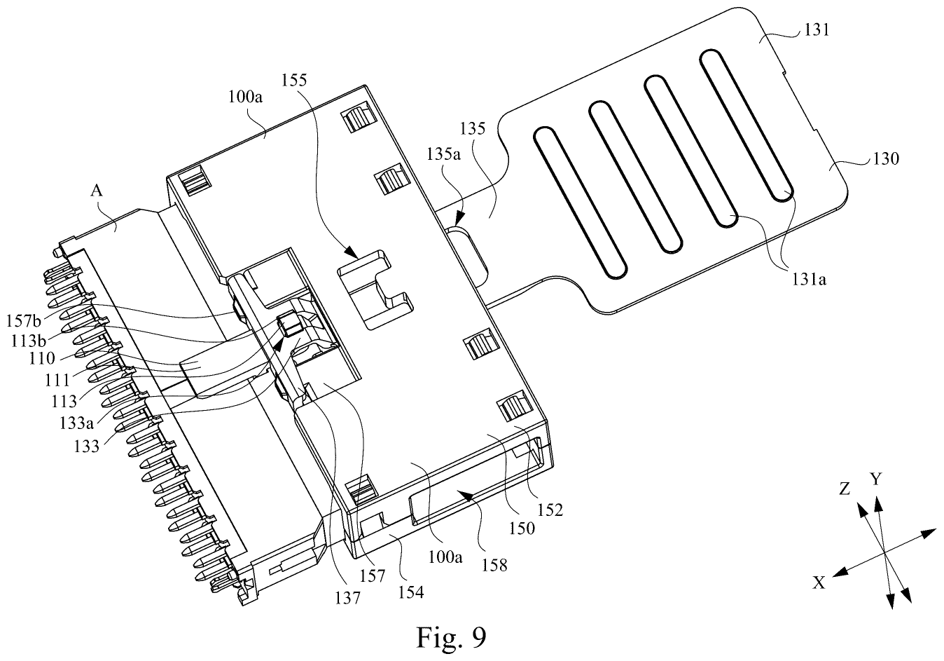

Please refer to FIG. 9, which is a perspective view of a cable-end connector 100a according to other embodiments. The cable-end connector 100a is generally the same as the cable-end connector 100, and the main difference is that cable terminals can be assembled from a lateral side of cable-end connector 100a. In this embodiment, the first housing 152 and the second housing 154 jointly form a through-hole 158 on the lateral side to accommodate the cable terminals.

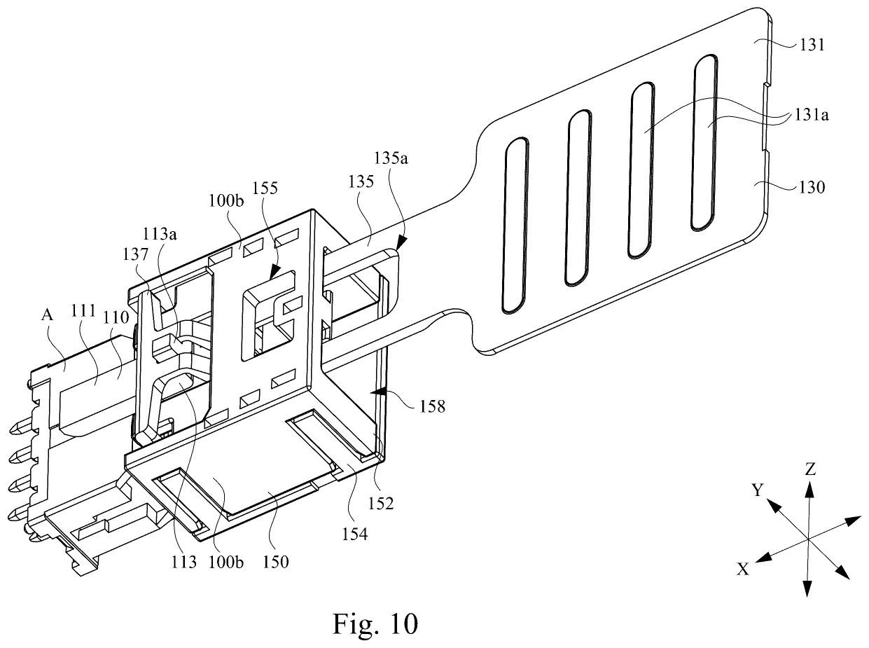

Please refer to FIG. 10, which is a perspective view of a cable-end connector 100b according to other embodiments. The cable-end connector 100b is generally the same as the cable-end connector 100, and the main difference is that the cable terminals can be assembled from a rear side of the cable-end connector 100b. In this embodiment, the first housing 152 and the second housing 154 jointly form a through-hole 158 at the rear side to accommodate the cable terminals.

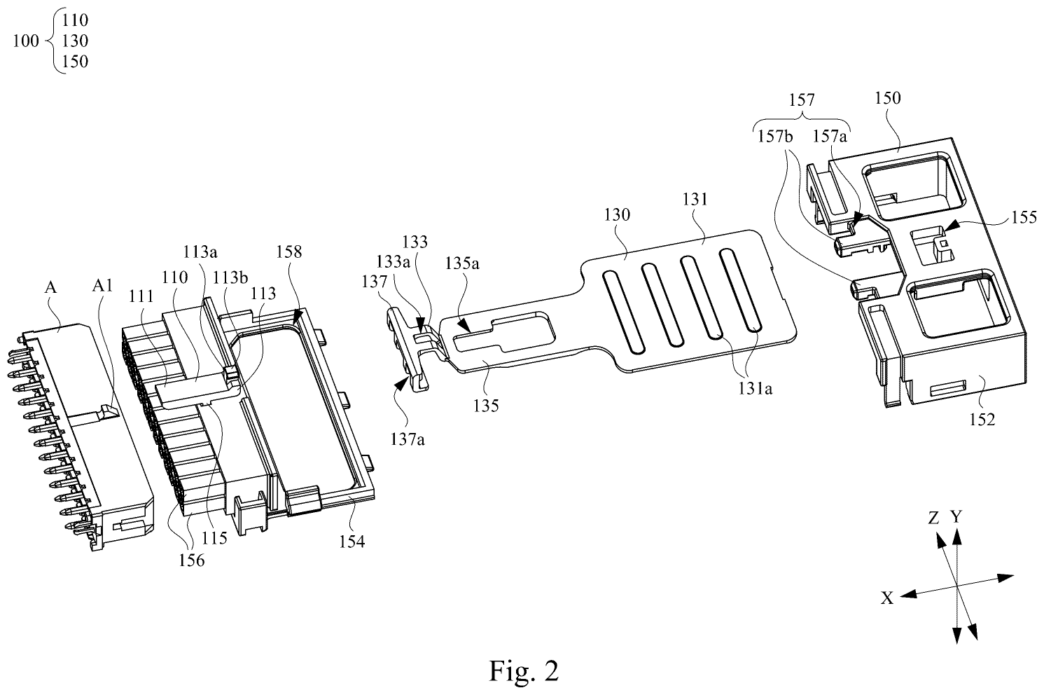

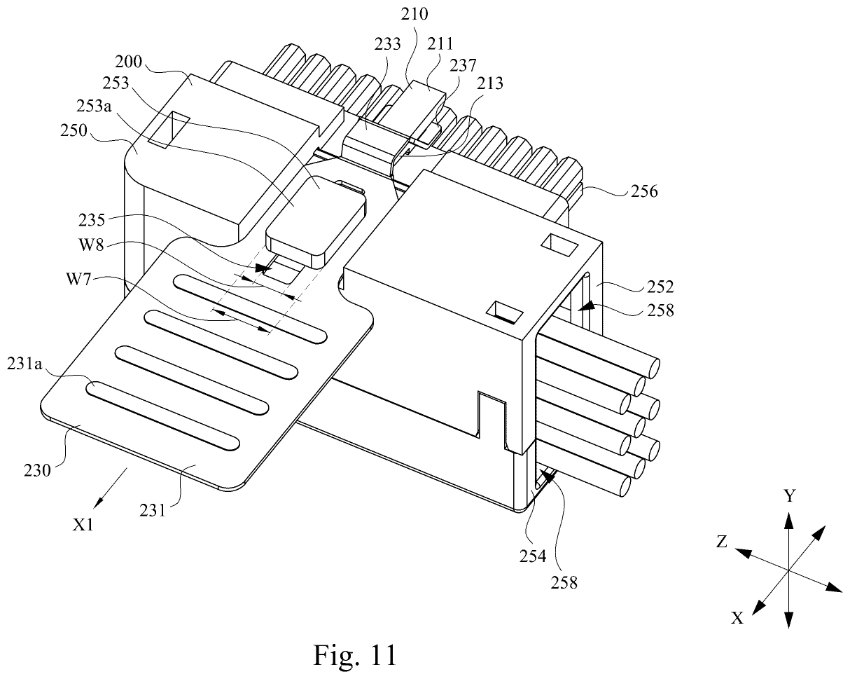

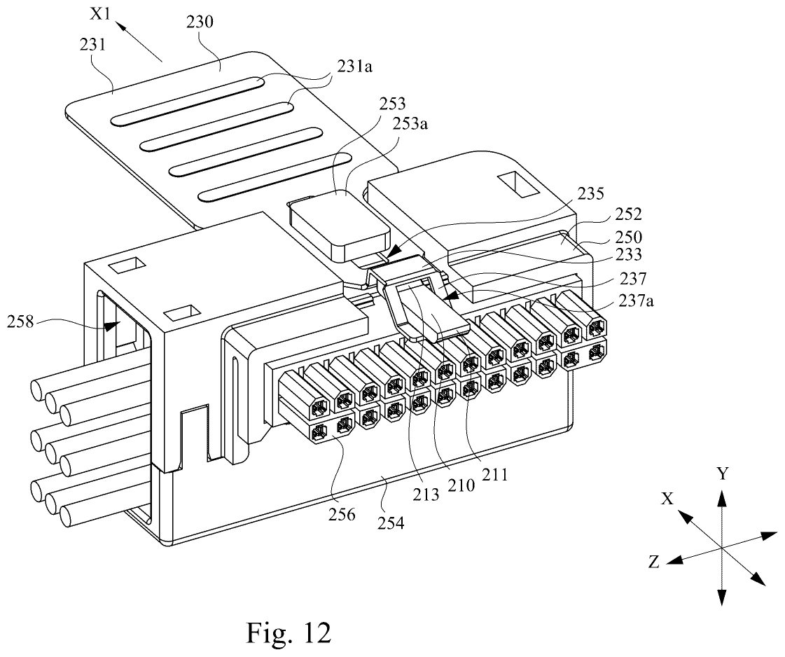

Please refer to FIGS. 11-12. FIG. 11 is a perspective view of a cable-end connector 200, and FIG. 12 is another perspective view of the cable-end connector 200. The cable-end connector 200 includes an elastic fixing unit 210, a pulling unit 230, and a housing 250. The elastic fixing unit 210 is connected to the housing 250. The pulling unit 230 is movably connected to the housing 250 and also engages with the connecting portion 215 of the elastic fixing unit 210. The pulling unit 230 can have limited movement relative to the housing 250, and the pulling unit 230 is movable relative to the housing 250 along the first axis X. Through the action of the pulling unit 230, the elastic fixing unit 210 can be actuated to release the mating connector A. For example, the cable-end connector 200 can fix the hook portion A1 of a mating connector A (please refer to FIG. 2) via the elastic fixing unit 210 to form a connector assembly. The various components of the cable-end connector 200 will be described in detail below.

The elastic fixing unit 210 includes a holding portion 211, a transmission portion 213, and a connecting portion 215 located between the holding portion 211 and the transmission portion 213. The holding portion 211 and the transmission portion 213 can move relative to each other with the connecting portion 215 as the center. Furthermore, the transmission portion 213 and the holding portion 211 are interlinked, so the movement of one will guide the subsequent movement of the other. In some embodiments, the elastic fixing unit 210 can be a seesaw-like assembly. The holding portion 211 and the transmission portion 213 are located at the two relatively moving ends of the seesaw-like assembly, and the connecting portion 215 can serve as a pivot of the seesaw-like assembly. Furthermore, the holding portion 211 is detachably connected to the mating connector A. The holding portion 211 may include a fixing hook, and the mating connector A includes a corresponding hook portion A1. The holding portion 211 is configured to move toward or away from the mating connector A, thereby causing the fixing hook to latch onto or release from the hook portion A1. In other embodiments, the elastic fixing unit 210 is a latch, and the holding portion 211 and the transmission portion 213 are two relatively moving ends of the latch. A user can pull or push the transmission portion 213 for driving the holding portion 211 to lock or unlock the hook portion A1.

The pulling unit 230 is a pull-tab and engages with the connecting portion 215. The pulling unit 230 includes a force-applying portion 231, a driving portion 233, and an assembly portion 237, and the driving portion 233 connected between the force-applying portion 231 and the assembly portion 237. The force-applying portion 231 is configured for a user to apply force, thereby driving the entire pulling unit 230 to move generally along the direction of the force X1. As the pulling unit 230 moves, the driving portion 233 moves toward the transmission portion 213 of the elastic fixing unit 210. This action, in turn, pulls the transmission portion 213 and the holding portion 211, thereby driving the transmission portion 213 and the holding portion 211 to move relative to each other around the connecting portion 215. The assembly portion 237 includes an assembly hole 237a that engages with the elastic fixing unit 210. An inner sidewall of the assembly hole 237a engages with the connecting portion 215. The connecting portion 215 can limit the assembly portion 237 to prevent the pulling unit 230 from detaching from the elastic fixing unit 210. Furthermore, the force-applying portion 231 may include a plurality of ribs 231a extending parallel to each other to facilitate user operation. However, the ribs 231a can be replaced with two adjacent force-applying holes 131b (referring to FIG. 8), and the disclosure is not limited thereto.

The housing 250 is connected to the elastic fixing unit 210, and the pulling unit 230 is movably connected to the housing 250 with limited relative movement along the first axis X. The housing 250 can provide structural support, protection, and positioning for the internal components of the cable-end connector 200. In some embodiments, the housing 250 further includes a first housing 252, a second housing 254, and a plurality of mating channels 256 that are joined together. The first housing 252 and the second housing 254 jointly form a through-hole 258 on a lateral side to accommodate cable terminals, and contact terminals can be arranged in the mating channels 256. Specifically, the mating channels 256 can be integrally formed with the first housing 252 or the second housing 254. However, the mating channels 256 can also be separate components. In other embodiments, the through-hole 258 can be located on a lateral side, a top side, or a bottom side of the housing 250, and the disclosure is not limited thereto.

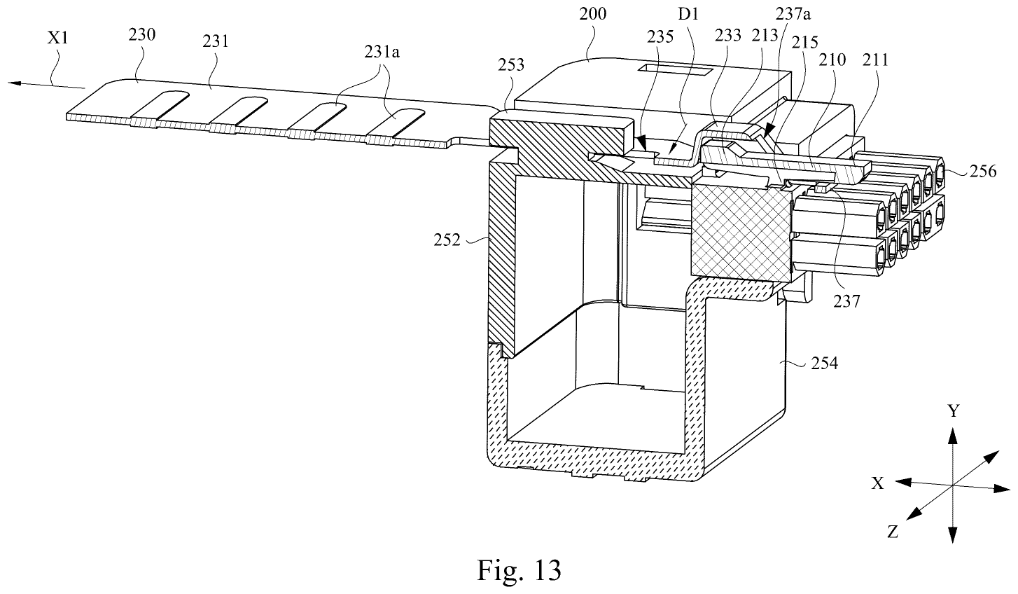

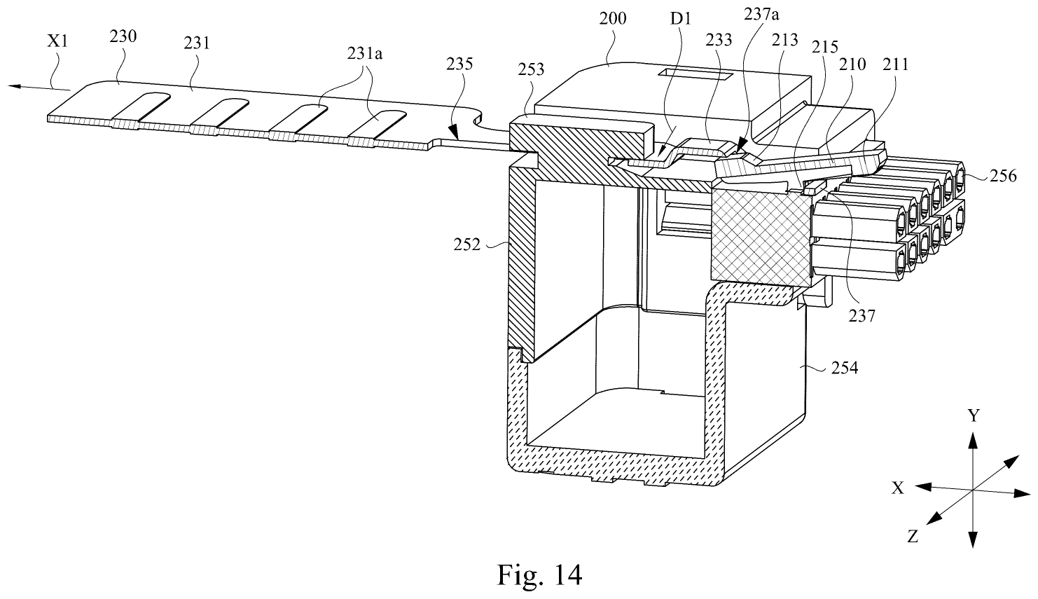

Please refer to FIGS. 13-14, which are perspective sectional views of the cable-end connector 200 showing different states. In some embodiments, the driving portion 233 can elastically deform when subjected to a force. The driving portion 233 is further configured to move by elastically deforming along a first direction D1 that is not parallel to the direction of the force X1. For example, the first direction D1 can be inclined or perpendicular to the direction of the force X1. The elastic deformation of the driving portion 233 along the first direction D1 can effectively press down on the transmission portion 213, and thus the holding portion 211 can lift up and move for unlocking.

Specifically, the driving portion 233 can be substantially L-shaped. A front portion of this L-shaped driving portion 233 can be located above the transmission portion 213. A rear end of the L-shaped driving portion is located on a side of the transmission portion 213 facing away from the holding portion 211. Therefore, the driving portion 233 can apply a force to the transmission portion 213. When the user pulls the pulling unit 230 along the direction of the force X1, the driving portion 233 will elastically deform into a flatter state along the first direction D1. This in turn drives the transmission portion 213 and the holding portion 211 to move.

In some embodiments, to guide and limit the movement of the pulling unit 230, the housing 250 may include a limiting portion 253. Correspondingly, the pulling unit 230 may include an elongated through-hole 235 extending along the direction of the force X1. The limiting portion 253 of the housing 250 is movably engaged with the elongated through-hole 235 of the pulling unit 230. When the pulling unit 230 moves to a pre-set position (e.g., where an end of the elongated through-hole 235 contacts the limiting portion 253), the limiting portion 253 will stop the pulling unit 230. This limits the movement of the pulling unit 230 relative to the housing 250 in the direction of the force X1.

Please refer to FIGS. 11 and 12. In some embodiments, the limiting portion 253 also limits the pulling unit 230 in a second direction perpendicular to the direction of the force X1 (e.g., the second axis Y). Such a design ensures that the pulling unit 230 maintains the intended movement, thereby preventing unnecessary deviation. Specifically, the first limiting portion 253 is substantially T-shaped and includes limiting arms 253a extending along opposite directions in the third axis Z. A width W7 of the limiting arms 253a is greater than a width W8 of the elongated through-hole 235. Therefore, the limiting arms 253a can limit the pulling unit 230 from above, so the pulling unit 230 can move straightly along the direction of the force X1, preventing the pulling unit 230 from moving along the second axis Y.

In summary, the connector design of the present disclosure significantly improves the disassembly process. Users can easily separate the cable-end connector from the mating connector without complicated operations. This not only greatly enhances work efficiency but also effectively reduces the risk of connector damage due to mis-handling. In addition, the present disclosure produces a special action through the elastic fixing unit, ensuring that the operation is labor-saving, simple, and highly reliable. Furthermore, various components (such as the limiting portion or the guiding portion) effectively guide the pulling unit to move accurately along a predetermined path. This comprehensively improves operational stability and extends the service life of the connector.

The foregoing descriptions are only preferred embodiments of the present disclosure and are not intended to limit the disclosure. Any modifications, equivalent replacements, improvements, etc., made within the spirit and principles of the present disclosure should be included within its scope of protection.

What is claimed is:

1. A connector assembly, comprising:
an elastic fixing unit having a holding portion and a transmission portion, wherein the holding portion and the transmission portion are interlinked;
a housing connected to the elastic fixing unit; and
a pulling unit movably connected to the housing and having a force-applying portion and a driving portion, wherein the driving portion engages with the transmission portion, the force-applying portion is configured to, upon receiving a force, drive the pulling unit to move along a direction of the force, such that the driving portion further drives the transmission portion and the holding portion to move.

2. The connector assembly of claim 1, wherein the housing comprises a guiding portion configured to guide the driving portion to move along a first direction not parallel to the direction of the force.

3. The connector assembly of claim 1, wherein the elastic fixing unit is a seesaw-like assembly, and the holding portion and the transmission portion are two relatively moving ends of the seesaw-like assembly.

4. The connector assembly of claim 1, wherein the transmission portion comprises a protruding body extending perpendicularly to the direction of the force, and the driving portion comprises a driving hole that engages with the protruding body.

5. The connector assembly of claim 4, wherein the protruding body comprises an extension portion extending along opposite directions of the protruding body, and a width of the extension portion is greater than a width of the driving hole.

6. The connector assembly of claim 1, wherein the housing comprises a first limiting portion, the pulling unit comprises an elongated through-hole extending along the direction of the force, and the first limiting portion is movably engaged with the elongated through-hole and is configured to stop the pulling unit when the pulling unit moves to a pre-set position along the direction of the force.

7. The connector assembly of claim 6, wherein the first limiting portion is configured to limit the pulling unit in a second direction perpendicular to the direction of the force.

8. The connector assembly of claim 6, wherein the housing comprises a window, and the window is aligned with the first limiting portion in a second direction perpendicular to the direction of the force.

9. The connector assembly of claim 1, wherein the pulling unit further comprises an assembly portion connected to the driving portion, the housing comprises a second limiting portion that engages with the assembly portion, and the second limiting portion is configured to limit the assembly portion in a planar direction perpendicular to the direction of the force.

10. The connector assembly of claim 9, wherein the second limiting portion comprises at least one limiting post extending in a direction opposite to the direction of the force, and the assembly portion comprises at least one assembly hole, wherein the at least one limiting post respectively engages with the at least one assembly hole.

11. The connector assembly of claim 1, wherein the force-applying portion comprises a plurality of ribs extending parallel to each other.

12. The connector assembly of claim 1, wherein the force-applying portion comprises two adjacent force-applying holes.

13. The connector assembly of claim 1, wherein the elastic fixing unit is a latch, the holding portion and the transmission portion are two relatively moving ends of the latch, and the pulling unit is a pull-tab.

14. A connector assembly, comprising:
an elastic fixing unit having a holding portion, a transmission portion, and a connecting portion located between the holding portion and the transmission portion, wherein the transmission portion and the holding portion are interlinked;
a housing fixing the elastic fixing unit via the connecting portion; and
a pulling unit movably connected to the housing and engaging with the connecting portion, wherein the pulling unit has a force-applying portion and a driving portion, the force-applying portion is configured to, upon receiving a force, drive the pulling unit to move along a direction of the force, such that the driving portion moves toward the transmission portion to pull and move the transmission portion and the holding portion.

15. The connector assembly of claim 14, wherein the driving portion is configured to move by elastically deforming along a first direction not parallel to the direction of the force.

16. The connector assembly of claim 14, wherein the driving portion is L-shaped and partially located above the transmission portion, one end of the driving portion located is on a side of the transmission portion facing away from the holding portion.

17. The connector assembly of claim 14, wherein the housing comprises a limiting portion, the pulling unit comprises an elongated through-hole extending along the direction of the force, and the limiting portion is movably engaged with the elongated through-hole and is configured to stop the pulling unit when the pulling unit moves to a pre-set position along the direction of the force.

18. The connector assembly of claim 17, wherein the limiting portion is configured to limit the pulling unit in a second direction perpendicular to the direction of the force.

19. The connector assembly of claim 18, wherein the limiting portion is T-shaped.

20. The connector assembly of claim 14, wherein the elastic fixing unit is a latch, the holding portion and the transmission portion are respectively two relatively moving ends of the latch, and the pulling unit is a pull-tab.
